(19) United States
(12) Patent Application Publication
(10) Pub. No.: US 2022/0157295 A1
(43) Pub. Date: May 19, 2022

(54) INFORMATION PROCESSING APPARATUS AND INFORMATION PROCESSING METHOD

(71) Applicant: SONY GROUP CORPORATION, TOKYO (JP)

(72) Inventors: HIRO IWASE, TOKYO (JP); YUHEI TAKI, TOKYO (JP); KUNIHITO SAWAI, TOKYO (JP)

(21) Appl. No.: 17/441,070

(22) PCT Filed: Jan. 22, 2020
(86) PCT No.: PCT/JP2020/002043

§ 371 Date: Sep. 20, 2021

(30) Foreign Application Priority Data
Mar. 29, 2019 (JP) 2019-066979

(51) Int. Cl. G10L 15/01; G10L 15/22; G10L 15/18; G06F 40/279; G06F 40/174; G06F 3/14

(52) U.S. Cl. CPC G10L 15/01; G10L 15/22; G06F 3/14; G06F 40/279; G06F 40/174; G10L 15/1815

(57) ABSTRACT

An information processing apparatus is provided that includes an output control unit that controls display of a table in which subjective evaluations that are made by a user on contents are collected, on the basis of an extracted intention of a speech of the user. The output control unit generates a comparison table in which the subjective evaluations are compared for each of contents related to a plurality of comparison targets, and displays the comparison table. Further, an information processing method is provided that includes controlling, by a processor, display of a table in which subjective evaluations that are made by a user on contents are collected, on the basis of an extracted intention of a speech of the user. The controlling includes generating a comparison table in which the subjective evaluations are compared for each of contents related to a plurality of comparison targets, and displaying the comparison table.

### FIELD

The present disclosure relates to an information processing apparatus and an information processing method.

### BACKGROUND

In recent years, with the improvement of performance of a voice recognition process, text input using voice has become widely used. With this technology, for example, it is possible to transcribe voice related to a subjective evaluation, such as a feedback or an opinion, made by a user with respect to a certain target into text, and record the text as a note.

Further, for example, in the course of day-to-day activities, a case in which it is desired to compare and examine a plurality of targets and make a certain determination often occurs, and a large number of mechanisms for assisting the determination as described above have been proposed. For example, Patent Literature 1 discloses a technology for improving search performance by extracting intended use and features from user reviews on products.

### CITATION LIST

### Patent Literature

Patent Literature 1: JP 2012-168925 A

### SUMMARY

### Technical Problem

However, a technique of transcribing speeches related to subjective evaluations made by a user with respect to a plurality of comparison targets into text, and organizing and presenting the text so as to be able to assist determination to be made by the user has not been implemented.

### Solution to Problem

According to the present disclosure, an information processing apparatus is provided that includes: an output control unit that controls display of a table in which subjective evaluations that are made by a user on contents are collected, on the basis of an extracted intention of a speech of the user, wherein the output control unit generates a comparison table in which the subjective evaluations are compared for each of contents related to a plurality of comparison targets, and displays the comparison table.

Moreover, according to the present disclosure, an information processing method is provided that includes: controlling, by a processor, display of a table in which subjective evaluations that are made by a user on contents are collected, on the basis of an extracted intention of a speech of the user, wherein the controlling includes generating a comparison table in which the subjective evaluations are compared for each of contents related to a plurality of comparison targets, and displaying the comparison table.

### BRIEF DESCRIPTION OF DRAWINGS

FIG. 1 is a diagram illustrating a configuration example of an information processing system according to one embodiment of the present disclosure.

FIG. 2 is a block diagram illustrating a functional configuration example of an information processing terminal 10 according to the present embodiment.

FIG. 3 is a block diagram illustrating a functional configuration example of an information processing server 20 according to the present embodiment.

FIG. 4 is a diagram for explaining generation of a comparison table according to the present embodiment.

FIG. 5 is a diagram for explaining generation of the comparison table according to the present embodiment.

FIG. 6 is a diagram for explaining generation of the comparison table according to the present embodiment.

FIG. 7 is a diagram for explaining generation of the comparison table according to the present embodiment.

FIG. 8 is a diagram for explaining generation of the comparison table according to the present embodiment.

FIG. 9 is a diagram illustrating an example of the comparison table based on subjective evaluation speeches of a plurality of users according to the present embodiment.

FIG. 10 is one example of the comparison table using comparison targets and users on axes according to the present embodiment.

FIG. 11 is a diagram for explaining use of ex-post subjective evaluations according to the present embodiment.

FIG. 12 is a diagram for explaining generation of a comparison table with respect to contents related to comparison targets for which some of comparison items are not common according to the present embodiment.

FIG. 13 is a diagram for explaining generation of the comparison table with respect to the contents related to the comparison targets for which some of the comparison items are not common according to the present embodiment.

FIG. 14 is a diagram for explaining generation of the comparison table with respect to the contents related to the comparison targets for which some of the comparison items are not common according to the present embodiment.

FIG. 15 is a flowchart illustrating the entire flow of control performed by the information processing server 20 according to the present embodiment.

FIG. 16 is a flowchart illustrating the flow of selection determination interaction control performed by the information processing server 20 according to the present embodiment.

FIG. 17A is a flowchart illustrating the flow of control of making a comparative evaluation criterion uniform by the information processing server 20 according to the present embodiment.

FIG. 17B is a flowchart illustrating the flow of control of making the comparative evaluation criterion uniform by the information processing server 20 according to the present embodiment

FIG. 18 is a diagram illustrating a hardware configuration example according to one embodiment of the present disclosure.

### DESCRIPTION OF EMBODIMENTS

Preferred embodiments of the present disclosure will be described in detail below with reference to the accompanying drawings. In the present specification and drawings, structural elements that have substantially the same functions and configurations are denoted by the same reference symbols, and repeated explanation will be omitted.

In addition, hereinafter, explanation will be given in the following order.

1. Embodiment
1.1. Background
1.2. System configuration example
1.3. Functional configuration example of information processing terminal 10
1.4. Functional configuration example of information processing server 20
1.5. Details of functions
1.6. Flow of operation
1.7. Other control

2. Hardware configuration example

3. Conclusion

### 1. EMBODIMENT

### 1.1. Background

As described above, in recent years, with the improvement of performance of a sound collecting device, such as a microphone, and a voice recognition process, text input using voice has become widely used, and it is expected that a voice input user interface (UI) will be installed in a wide variety of products and services, and text input based on speeches will become more common in the future.

Meanwhile, a current voice input UI is usually installed to interpret an intention of a speech related to a request from a user for operation on an agent device that has a voice interaction function, and, in the agent device as described above, technologies for voice recognition, natural language understanding, semantic interpretation, and the like are used.

Further, a technology for transcribing a speech related to a subjective evaluation, such as a feedback or an opinion, made by a user with respect to a certain target (hereinafter, the speech may also be referred to as subjective evaluation speech) into text, and recording the text as a note has been known. However, for example, when the user compares and examines a plurality of targets, it is difficult to intuitively recognize complicated factors and trade-off relationships with respect to comparison items included in the targets only by recording and presenting the text, as the note, of the subjective evaluation speech as described above, and it is presumed that the note does not function as sufficient information for making a decision.

The technical idea according to the present disclosure has been conceived in view of the foregoing situations, and makes it possible to accurately organize divergent feedbacks and opinions of the user with respect to a plurality of comparison targets without a burden on the user. To cope with this, an information processing method according to one embodiment of the present disclosure includes control of causing a processor to display a table in which subjective evaluations made by a user on contents are collected, on the basis of extracted intentions of speeches of the user. Further, the control as described above further includes generation of a comparison table in which the subjective evaluations are compared for each of contents related to a plurality of comparison targets, and display of the comparison table.

A system configuration for implementing the information processing method with the features as described above will be described in detail below.

### 1.2. System Configuration Example

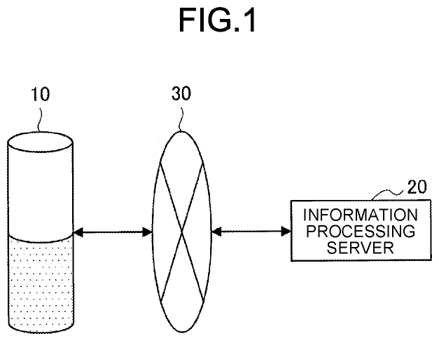

FIG. 1 is a diagram illustrating a configuration example of an information processing system according to the present embodiment. As illustrated in FIG. 1, the information processing system according to the present embodiment includes an information processing terminal 10 and an information processing server 20. Further, the information processing terminal 10 and the information processing server 20 are communicably connected to each other via a network 30.

Information Processing Terminal 10

The information processing terminal 10 according to the present embodiment is an information processing apparatus that collects a speech made by a user, and presents various kinds of information based on a result of speech recognition and natural language understanding performed by the information processing server 20.

The information processing terminal 10 according to the present embodiment may be, for example, a smartphone, a tablet, a personal computer (PC), a wearable device, or the like. Further, the information processing terminal 10 according to the present embodiment may be a dedicated terminal of a stationary type or an autonomous mobile type.

Information Processing Server 20

The information processing server 20 according to the present embodiment is an information processing apparatus that performs speech recognition and natural language understanding based on the speech of the user collected by the information processing terminal 10, and generates a comparison table in which subjective evaluations made by the user are compared for each of contents related to a plurality of comparison targets. Further, the information processing server 20 has a function to control the information processing terminal 10 and display the comparison table as described above.

Network 30

The network 30 has a function to connect the information processing terminal 10 and the information processing server 20. The network 30 may include a public line network, such as the Internet, a telephone network, or a satellite communication network, or various local area networks (LANs) and wide area networks (WANs) including Ethernet (registered trademark). Further, the network 30 may include a dedicated line network including Internet protocol-virtual private network (IP-VPN) or the like. Furthermore, the network 30 may include a radio communication network, such as Wi-Fi (registered trademark) or Bluetooth (registered trademark).

The configuration example of the information processing system according to one embodiment of the present disclosure has been described above. Meanwhile, the configuration as described above with reference to FIG. 1 is one example, and the configuration of the information processing system according to the present embodiment is not limited to this example. For example, the functions included in the information processing terminal 10 and the information processing server 20 according to the present embodiment may be implemented by a single information processing apparatus. The configuration of the information processing system according to the present embodiment may be flexibly modified depending on specification and operation.

### 1.3. Functional Configuration Example of Information Processing Terminal 10

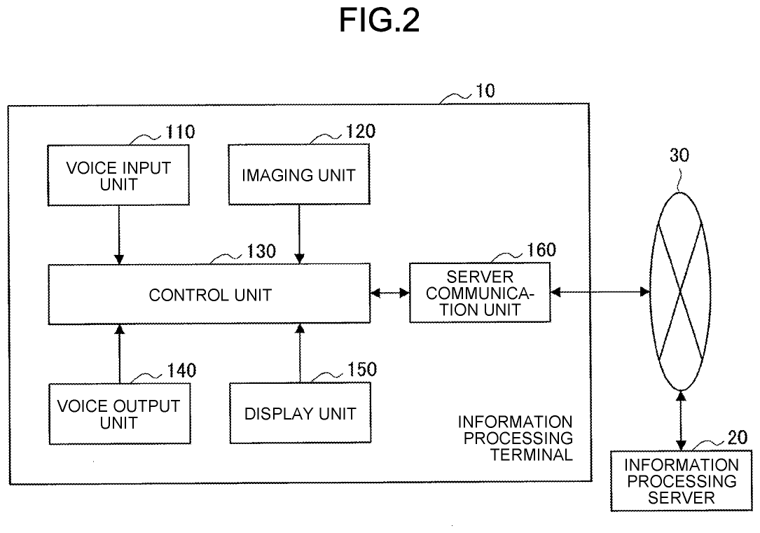

A functional configuration example of the information processing terminal 10 according to the present embodiment will be described below. FIG. 2 is a block diagram illustrating the functional configuration example of the information processing terminal 10 according to the present embodiment. As illustrated in FIG. 2, the information processing terminal 10 according to the present embodiment includes a voice input unit 110, an imaging unit 120, a control unit 130, a voice output unit 140, a display unit 150, and a server communication unit 160.

Voice Input Unit 110

The voice input unit 110 according to the present embodiment mainly has a function to collect voice related to the speech made by the user. The voice collected by the voice input unit 110 is used for a voice recognition process, natural language understanding, and the like performed by the information processing server 20. The voice input unit 110 according to the present embodiment includes a microphone for collecting voice. Meanwhile, if it is assumed that the information processing terminal 10 is used by a plurality of users, the voice input unit 110 may include a plurality of microphones for detecting directions of sound sources.

Imaging Unit 120

The imaging unit 120 according to the present embodiment mainly has a function to capture an image of the user. To cope with this, the imaging unit 120 according to the present embodiment includes an imaging element.

Control Unit 130

The control unit 130 according to the present embodiment has a function to control each of the components included in the information processing terminal 10. The control unit 130 may control, for example, activation, start, and the like of each of the components. Further, the control unit 130 according to the present embodiment may have the same functions as those of an output control unit 250 of the information processing server 20.

Voice Output Unit 140

The voice output unit 140 according to the present embodiment has a function to output synthetic voice related to a system speech, mainly on the basis of control performed by the output control unit 250 of the information processing server 20. To cope with this, the voice output unit 140 according to the present embodiment includes a speaker and an amplifier.

Display Unit 150

The display unit 150 according to the present embodiment has a function to display contents related to comparison targets and a comparison table, mainly on the basis of control performed by the output control unit of the information processing server 20. To cope with this, the display unit 150 according to the present embodiment includes various display devices, a projector, and the like.

Server Communication Unit 160

The server communication unit 160 according to the present embodiment performs information communication with the information processing server 20 via the network 30. For example, the server communication unit 160 transmits the voice data related to the speech of the user collected by the voice input unit 110 to the information processing server 20. Further, for example, the server communication unit 160 receives contents related to comparison targets, a comparison table generated by the output control unit 250, and the like from the information processing server 20.

Thus, the functional configuration example of the information processing terminal 10 according to the present embodiment has been described above. Meanwhile, the configuration as described above with reference to FIG. 2 is one example, and the functional configuration of the information processing terminal 10 according to the present embodiment is not limited to this example. The functional configuration of the information processing terminal 10 according to the present embodiment may be flexibly modified depending on specification and operation.

### 1.4. Functional Configuration Example of Information Processing Server 20

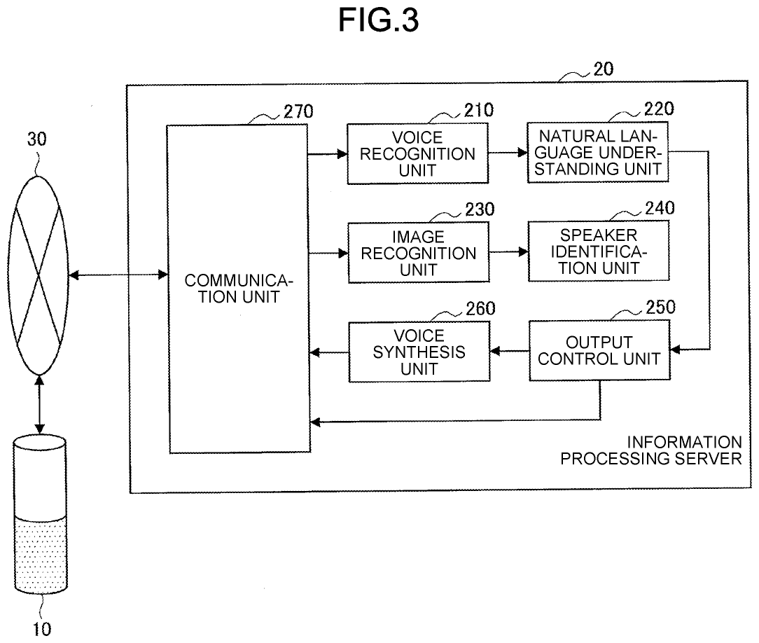

A functional configuration example of the information processing server 20 according to the present embodiment will be described below. FIG. 3 is a block diagram illustrating a functional configuration example of the information processing server 20 according to the present embodiment. As illustrated in FIG. 3, the information processing server 20 according to the present embodiment includes a voice recognition unit 210, a natural language understanding unit 220, an image recognition unit 230, a speaker identification unit 240, the output control unit 250, a voice synthesis unit 260, and a communication unit 270.

Voice Recognition Unit 210

The voice recognition unit 210 according to the present embodiment has a function to perform speech recognition (automatic speech recognition (ASR)) on the voice data of the speech of the user collected by the information processing terminal 10, and transcribe the speech of the user into text.

Natural Language Understanding Unit 220

The natural language understanding unit 220 according to the present embodiment performs natural language understanding (NLU) on the text of the speech of the user transcribed by the voice recognition unit 210, and extracts an intent and an entity related to the speech. Meanwhile, if the speech of the user is the subjective evaluation speech, the natural language understanding unit 220 may extract a comparison item as the intent, extract a subjective expression as the entity, and calculate a subjective evaluation score from the subjective expression. Details of the functions of the natural language understanding unit 220 according to the present embodiment will be described later.

Image Recognition Unit 230

The image recognition unit 230 according to the present embodiment mainly has a function to identify a user and recognize a position of the user, on the basis of the image of the user captured by the information processing terminal 10.

Speaker Identification Unit 240

The speaker identification unit 240 according to the present embodiment has a function to identify a user who has made a speech in a situation in which the information processing system is used by a plurality of users. For example, the speaker identification unit 240 according to the present embodiment may detect a direction of a sound source on the basis of voice collected by a plurality of microphones included in the voice input unit 110 of the information processing terminal 10, and identify, as the speaker, a user who is present in the detected direction of the sound source on the basis of information that is input from the image recognition unit 230. Further, the speaker identification unit 240 is also able to learn voice quality of voice spoken by each of the users in advance, and identify a speaker on the basis of features of the voice quality.

Output Control Unit 250

The output control unit 250 according to the present embodiment has a function to control display of a table in which subjective evaluations made by the user on contents are collected, on the basis of an intention of the speech of the user extracted by the natural language understanding unit 220. In this case, the output control unit 250 according to the present embodiment generates a comparison table, in which subjective evaluations are compared for each of contents related to a plurality of comparison targets, and causes the display unit 150 of the information processing terminal 10 to display the comparison table. In this case, the output control unit 250 according to the present embodiment may generate the comparison table in which the subjective evaluations are compared for each of comparison items included in the contents related to the comparison targets.

Furthermore, the subjective evaluations as described above may include subjective expressions with respect to comparison items extracted from the speech of the user, and subjective evaluation scores that are calculated from the subjective expressions. In this case, the output control unit 250 according to the present embodiment generates the comparison table in which the subjective expressions and the subjective evaluation scores are compared for each of the comparison items. Details of the functions of the output control unit 250 according to the present embodiment will be described later.

Voice Synthesis Unit 260

The voice synthesis unit 260 according to the present embodiment has a function to synthesize voice (text to speech (TTS)) on the basis of control performed by the output control unit 250, and generate synthetic voice related to a system speech. The synthetic voice generated by the voice synthesis unit 260 is transmitted to the information processing terminal 10 and output by the voice output unit 140.

Communication Unit 270

The communication unit 270 according to the present embodiment performs information communication with the information processing terminal 10 via the network 30. For example, the communication unit 270 receives the voice data related to the speech of the user from the information processing terminal 10. Further, for example, the communication unit 270 transmits the contents related to the comparison targets, the comparison table generated by the output control unit 250, and the synthetic voice generated by the voice synthesis unit 260 to the information processing terminal 10.

Thus, the functional configuration example of the information processing server 20 according to one embodiment of the present disclosure has been described above. Meanwhile, the functional configuration as described above with reference to FIG. 3 is one example, and the functional configuration of the information processing server 20 according to the present embodiment is not limited to this example. The functional configuration of the information processing server 20 according to the present embodiment may be flexibly modified depending on specifications and operation.

### 1.5. Details of Functions

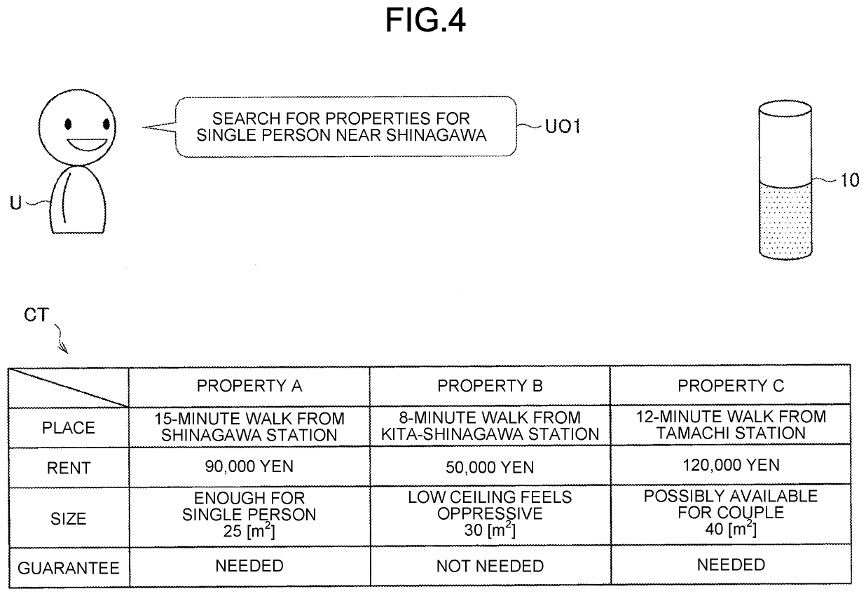

The functions of the information processing server 20 according to the present embodiment will be described in detail below with reference to specific examples. First, one example will be described in which a user virtually performs property viewing by using the information processing terminal 10 that is a virtual reality (VR) device or the information processing terminal 10 that is an agent device will be described. FIG. 4 to FIG. 8 are diagrams for explaining generation of a comparison table according to the present embodiment. Meanwhile, in FIG. 4 to FIG. 8, one example is illustrated in which a user U performs property viewing by viewing images of properties displayed by the information processing terminal 10 that is the agent device.

First, as illustrated in an upper part in FIG. 4, the user U makes a speech UO1 indicating a request to search for properties, that is, contents related to comparison targets. In this case, the natural language understanding unit 220 according to the present embodiment performs natural language understanding on the speech UO1 that is transcribed into text by the voice recognition unit 210, and extracts, as an intention of the speech, “search under conditions of “for single person near Shinagawa””.

Subsequently, the output control unit 250 according to the present embodiment searches through a property database on the basis of the intention of the speech extracted by the natural language understanding unit 220, and acquires image information or the like on properties A to C as the contents related to the comparison targets.

Furthermore, the output control unit 250 according to the present embodiment acquires, from the property database, initial comparison items corresponding to the acquired comparison targets, and attribute values of the comparison items, and generates a comparison table including the comparison items and the attribute values.

In the example illustrated in FIG. 4, the output control unit 250 acquires, as the comparison items, a “place” that meets the condition in a search instruction issued by the user U, a “rent” and a “size” for which a statistically large number of people has made subjective evaluations, and a “guarantee” that may be a constraint condition.

Furthermore, in the example illustrated in FIG. 4, a distance from a closest station is acquired as the attribute value of the comparison item of “place”, a monthly rent is acquired as the attribute value of the comparison item of “rent”, a proprietary area and details that are represented as the subjective evaluations by the statistically largest number of people are acquired as the attribute of the comparison item of “size”, and necessity of a guarantee is acquired as the attribute value of the comparison item of “guarantee”.

In this case, the output control unit 250 according to the present embodiment may generate, as illustrated in the figure for example, a comparison table CT in the form of a list in which a horizontal axis represents the properties A to C as the comparison targets and a vertical axis represents the acquired comparison items of “place”, “rent”, “size”, and “guarantee”, and present the attribute values for each of the comparison items to the user U.

Meanwhile, at the time as illustrated in FIG. 4, subjective evaluations made by the user U are not included in the comparison table CT, and only the attribute values as described above are displayed.

Here, if the user U makes a speech of “show contents in sequence” or the like, the output control unit 250 according to the present embodiment controls the display unit 150 of the information processing terminal 10 and starts to present the contents related to the comparison targets. In this case, the output control unit 250 may perform control of temporarily stopping display of the comparison table CT including the initial comparison items and the attribute values illustrated in FIG. 4, or may move the comparison table CT to a certain position such that viewing of the contents related to the comparison targets is not disturbed.

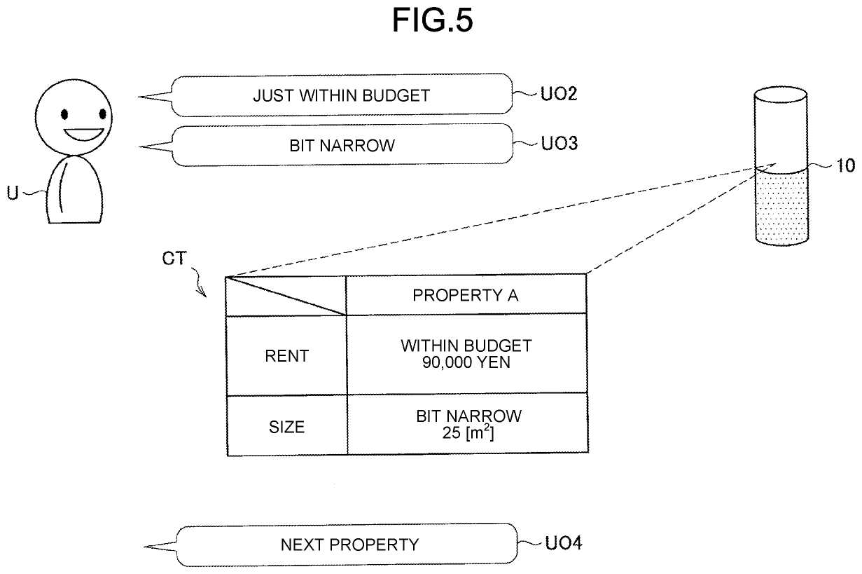

In an upper part in FIG. 5, subjective evaluation speeches UO2 and UO3 made by the user U who has viewed the property A with the contents related to the comparison targets for which the presentation is controlled by the output control unit 250 are illustrated. Here, the subjective evaluation speeches according to the present embodiment indicate speeches related to evaluations, such as subjective feedbacks or opinions, made by the user with respect to the contents related to the comparison targets.

In this case, the natural language understanding unit 220 according to the present embodiment extracts, from the subjective evaluation speeches made by the user, the comparison items as intents and subjective expressions as entities. For example, by learning, in advance, model sentences in which the comparison items and the subjective expressions are associated, the natural language understanding unit 220 is able to extract the comparison items and the subjective expressions as the intents and the entities on the basis of learned data even with respect to a speech made by an unknown user.

More specifically, for example, by performing, in advance, learning using a model sentence of “room is a bit shabby” and teaching data including an intent=a comparison item of “interior” and an entity=a subjective expression of “bit shabby”, the natural language understanding unit 220 is able to correctly extract the intent and the entity from a similar speech.

Further, through an emotion analysis process or the like, the natural language understanding unit 220 calculates a subjective evaluation score that indicates a measure of whether the speech (subjective expression) of the user is negative or positive. For example, the subjective evaluation score may be defined in a range from −1.0 (negative) to 1.0 (positive) including 0.0 (neutral).

For example, the subjective expression of “bit shabby” that is extracted from “room is a bit shabby” as described above is a negative expression, and therefore, the natural language understanding unit 220 may obtain −0.3 by calculation of the subjective evaluation score.

Furthermore, as for the subjective evaluation UO2 illustrated in FIG. 5, the natural language understanding unit 220 may extract an intent=the comparison item of “rent” and an entity=a subjective expression of “just within budget”, and may obtain 0.3 as the subjective evaluation score.

Moreover, as for the subjective evaluation UO3, the natural language understanding unit 220 may extract an intent=the comparison item of “size” and an entity=a subjective expression of “bit narrow”, and may obtain −0.3 as the subjective evaluation score.

In this case, the output control unit 250 according to the present embodiment may store the comparison items, the subjective expressions, and the subjective evaluation scores that are extracted from the subjective evaluation speeches UO2 and UO3 by the natural language understanding unit 220, may generate the comparison table CT in which the horizontal axis represents the property A as the comparison target and the vertical axis represents the comparison items of “rent” and “size”, and display the subjective expressions of “just within budget” and “bit narrow” in cells of the respective comparison items.

Furthermore, the output control unit 250 may additionally display the attribute values of the respective comparison items obtained from the property database. Meanwhile, in this case, to distinguish between the subjective expressions of the user and the attribute values, font colors, font types, decorations, or the like may be changed.

Here, if the user U makes a speech UO4 for designating presentation of the content related to the next comparison target, the output control unit 250 proceeds to control of presenting the property B.

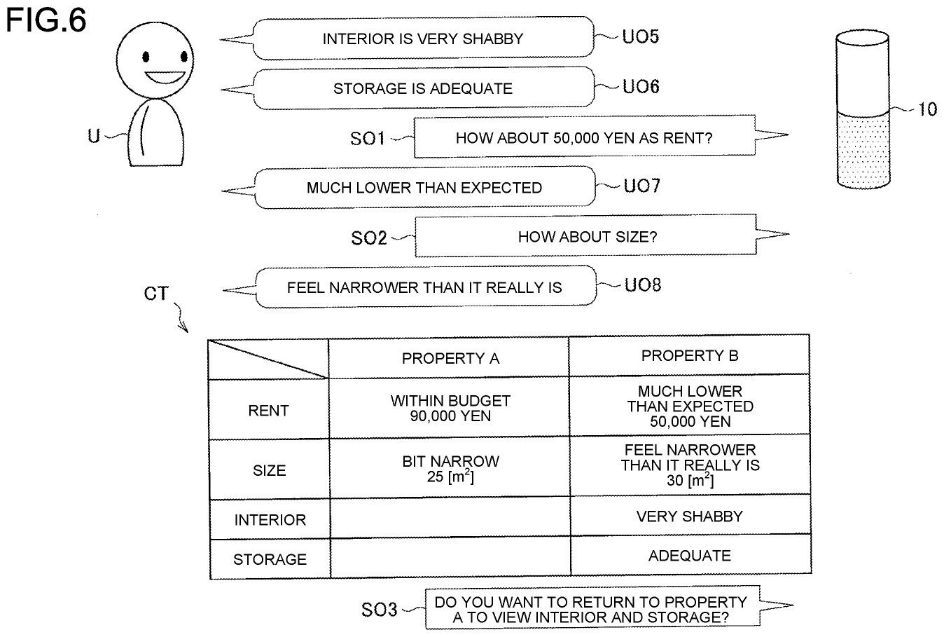

In an upper part in FIG. 6, subjective evaluation speeches UO5 and UO6 made by the user U who has viewed the property B that is the comparison target for which presentation is controlled by the output control unit 250 are illustrated. In this case, similarly to the case as illustrated in FIG. 5, the output control unit 250 extracts the comparison items and the subjective expressions from each of the subjective expressions, and calculates the subjective evaluation scores from the subjective expressions. Further, the output control unit 250 adds the extracted comparison items and the extracted subjective expressions to the comparison table CT.

Here, intents=comparison items of “interior” and “storage” extracted from the subjective evaluation speech UO5 are comparison items that are not included in the initial comparison table CT that is based on the property database. If a new comparison item is extracted from the subjective evaluation speech of the user as described above, the output control unit 250 according to the present embodiment may add the new comparison item to the comparison table CT. With this control, it is possible to generate the comparison table CT that includes an element that is regarded as important by the user, independent of the initial setting.

Further, in the example illustrated in FIG. 6, the user U who has viewed the property B does not mention about the comparison items of “rent” and “size” for which the subjective evaluation speeches are made with respect to the previous property A. In this manner, if the comparison items for which the subjective evaluations are not obtained are present, the output control unit 250 may cause the voice output unit 140 of the information processing terminal 10 to output system speeches SO1 and SO2 to request the user to make subjective evaluation speeches on the comparison items.

More specifically, the output control unit 250 according to the present embodiment controls a system speech such that, with respect to the comparison items for which the subjective evaluations are obtained in the contents related to one or more comparison targets, subjective evaluations can be obtained in the contents related to all of the comparison targets.

Here, if the user U makes a subjective evaluation speech UO7 with respect to the comparison item of “rent” in response to a system speech SO1, the output control unit 250 extracts a subjective expression of “much lower than expected” from the subjective evaluation speech UO7 and adds the subjective expression to the comparison table CT. Further, the output control unit 250 calculates a subjective evaluation score from the subjective expression of “much lower than expected” and stores the subjective evaluation score.

Similarly, if the user U makes a subjective evaluation speech UO7 with respect to the comparison item of “size” in response to a system speech SO2, the output control unit 250 extracts a subjective expression of “feel narrower than it really is” from the subjective evaluation speech UO7 and adds the subjective expression to the comparison table CT. Further, the output control unit 250 calculates a subjective evaluation score from the subjective expression of “feel narrower than it really is” and stores the subjective evaluation score.

In this manner, the output control unit 250 according to the present embodiment is able to further control a voice interaction with the user with respect to the contents related to the comparison targets, and generate the comparison table based on the intention of the speech of the user extracted in the voice interaction.

Furthermore, in the example illustrated in FIG. 6, the new comparison items of “interior” and “storage” have been added by viewing of the property B, but the user U has not made subjective evaluation speeches on the above-described two comparison items with respect to the property A.

In this manner, if the comparison items for which the subjective evaluations have not been obtained in the already-presented contents related to the comparison targets are present, the output control unit 250 according to the present embodiment may control a proposal for re-presentation of the already-presented contents related to the comparison targets. In the example illustrated in FIG. 6, the output control unit 250 causes the voice output unit 140 of the information processing terminal 10 to output a system speech SO3 that proposes return to the property A to view an interior and a storage.

According to the control performed by the output control unit 250 of the present embodiment as described above, by generating an opportunity to obtain the subjective evaluation speeches of the user on the same comparison items with respect to the contents related to all of the comparison targets, it is possible to make a criterion to be used in a subsequent comparative examination uniform.

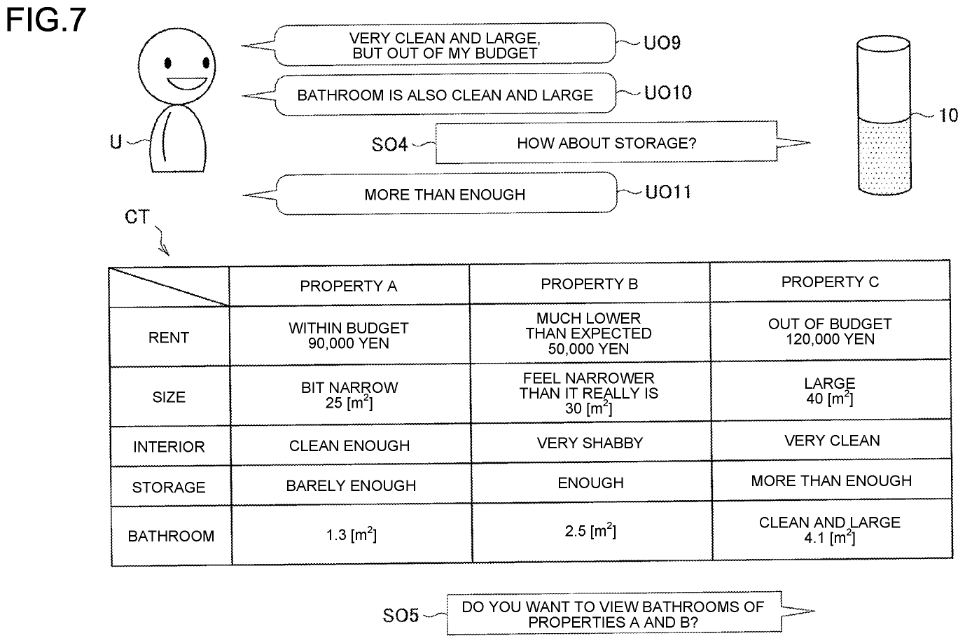

Moreover, in an upper part in FIG. 7, subjective evaluation speeches UO9 and UO10 made by the user U who has viewed the property C are illustrated. In this case, similarly to the above, the output control unit 250 extracts comparison items of “interior”, “size”, “rent”, and “bathroom” and subjective expressions corresponding to the respective comparison items, and calculates subjective evaluation scores.

Furthermore, the output control unit 250 may cause the voice output unit 140 of the information processing terminal 10 to output a system speech SO4 indicating a request for a subjective evaluation speech on the comparison item of “storage” for which a subjective evaluation has not been obtained with respect to the property C.

Moreover, with regard to the new comparison item of “bathroom” for which the subjective evaluation speech has been made by viewing of the property C but subjective evaluation speeches have not been made with respect to the other properties, if it is possible to acquire attributes from the property database, the output control unit 250 may add the attribute values to the comparison table CT and thereafter output a system speech SO5 that proposes re-presentation of the property A and the property B. In this manner, if the comparison item for which the subjective evaluations have not been obtained in the contents related to a plurality of comparison targets is present, the output control unit 250 may display the attribute values in consideration of a burden on the user to view the contents related to the plurality of comparison targets again.

As described above, if viewing of the contents related to the comparison targets is completed, the output control unit 250 generates the final comparison table CT in which the subjective evaluation scores that are calculated for the respective comparison items as illustrated in FIG. 5 to FIG. 7 are reflected. In this case, the output control unit 250 according to the present embodiment may generate the comparison table CT in which the subjective evaluation scores are represented in the background of the comparison items.

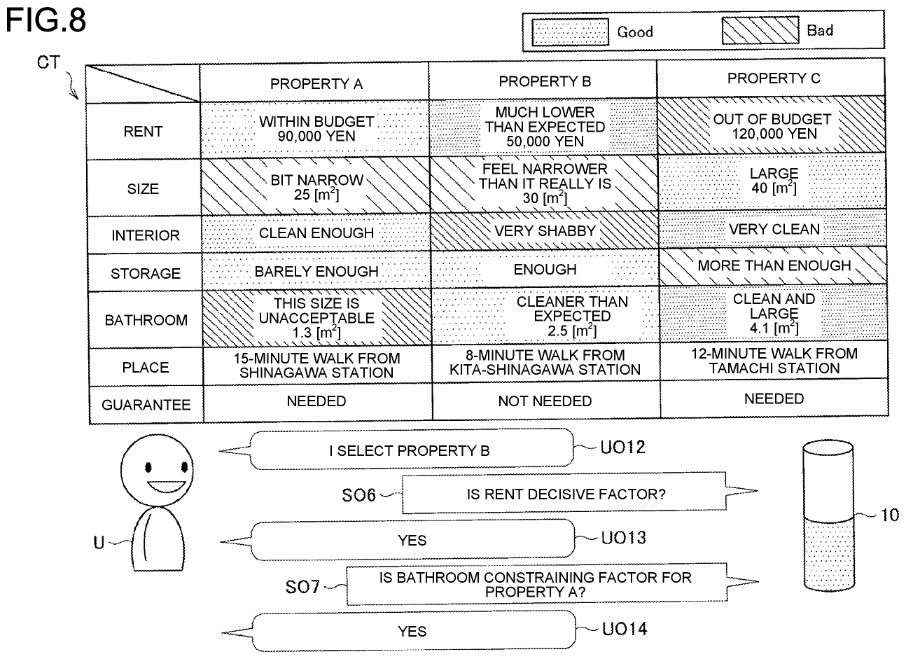

For example, as illustrated in FIG. 8, the output control unit 250 according to the present embodiment may generate the comparison table CT in which polarities and magnitudes of the subjective evaluation scores are represented by different colors, different patterns, and different density of backgrounds of the comparison items, and cause the display unit 150 to display the comparison table CT. For example, the output control unit 250 may color the backgrounds of the cells of the comparison items blue if the subjective evaluation scores are negative and red if the subjective evaluation scores are positive, and represent absolute values of the scores by changing color density.

According to the comparison table as described above, the user is able to visually and intuitively recognize the subjective evaluations that are made for the respective comparison items in the contents related to all of the comparison targets, so that it is possible to effectively assist the user in performing a comparative examination.

Furthermore, as illustrated in FIG. 8, if the user U who has confirmed the comparison table CT makes a speech UO12 for determining the property, the output control unit 250 according to the present embodiment may estimate the comparison item that serves as a decisive factor for the determination made by the user, on the basis of the subjective evaluation scores.

In this case, for example, the output control unit 250 may estimate, as the decisive factor, a certain comparison item for which a difference in the subjective evaluation score from the non-selected properties A and C is the largest in the positive direction among the comparison items of the selected property B. Alternatively, the output control unit 250 may estimate, as the decisive factor, a certain comparison item that has the largest subjective evaluation score among the comparison items of the selected property B.

Moreover, the output control unit 250 according to the present embodiment may estimate a comparison item that may serve as a (negative) constraining factor of the contents related to the comparison targets that are not selected by the user U, on the basis of the subjective evaluation scores.

In this case, for example, the output control unit 250 may estimate, as the constraining factor, a certain comparison item for which a difference in the subjective evaluation score from the selected property B is the largest in the negative direction among the comparison items of the non-selected properties. Alternatively, the output control unit 250 may estimate, as the constraining factor, a certain comparison item that has the smallest subjective evaluation score among the comparison items of the non-selected properties.

Furthermore, the output control unit 250 may cause the voice output unit 140 to output system speeches SO6 and SO7 for confirming the user U the comparison items that are estimated, in advance, as the decisive factor and the constraining factor.

Moreover, the output control unit 250 according to the present embodiment has a function to accumulate the decisive factor and the constraining factor that are estimated as described above, and statistically analyze the decisive factor and the constraining factor. Meanwhile, if the user indicates a different factor when the user is requested to confirm the estimated decisive factor and the estimated constraining factor by using the system speech or the like, the output control unit 250 may accumulate the factor indicated by the user. For example, if the user gives a response of “No, because bathroom is clean” or the like in response to the system speech SO, the output control unit 250 may accumulate, as the decisive factor, “bathroom” indicated by the user, instead of the estimated “rent”. By accumulating and statistically analyzing the estimated decisive factor and the estimated constraining factor as described above, the output control unit 250 according to the present embodiment is able to provide information that is useful for improving operation performed by a contents provider side.

For example, a statistically major decisive factor can be regarded as being useful as a selling point of other properties, and therefore, if it is estimated that a large number of users use rent as the decisive factor as a result of analysis performed by the output control unit 250, it is expected to increase sales by increasing the number of properties with lower rent and advertising the properties.

Furthermore, for example, it may be expected to give, to the contents provider, a suggestion to improve the constraining factor of the contents related to the non-selected comparison targets. For example, in the example illustrated in FIG. 8, it is assumed that the comparison item of “bathroom” is the constraining factor among the comparison items of the property A. In this case, it may be possible to provide an owner with information on a suggestion of refurbish of a bathroom of the property A.

Thus, generation of the comparison table according to the present embodiment has been described above. Meanwhile, in the above description, the case has been described in which the output control unit 250 generates the comparison table based on the subjective evaluation speeches made by the single user, but in a case of a comparative examination performed by a plurality of users, the output control unit 250 according to the present embodiment is able to generate an integrated comparison table in which subjective evaluations made by each of the users are reflected, on the basis of subjective evaluation speeches made by the plurality of users.

An example of a case will be described below in which four users, that is, a father, a mother, a sister, and a brother, request the information processing terminal 10 that is a home agent device to search for a restaurant, and make subjective evaluation speeches while viewing a plurality of presented restaurants, that is, the contents related to the comparison targets. Meanwhile, even in this case, similarly to the case of the single user, the output control unit 250 may add comparison items that are newly extracted from the subjective evaluation speeches to the comparison table. Further, the output control unit 250 may perform control of requesting the users to make subjective evaluation speeches with respect to a comparison item for which a subjective evaluation speech is not obtained from any of the users.

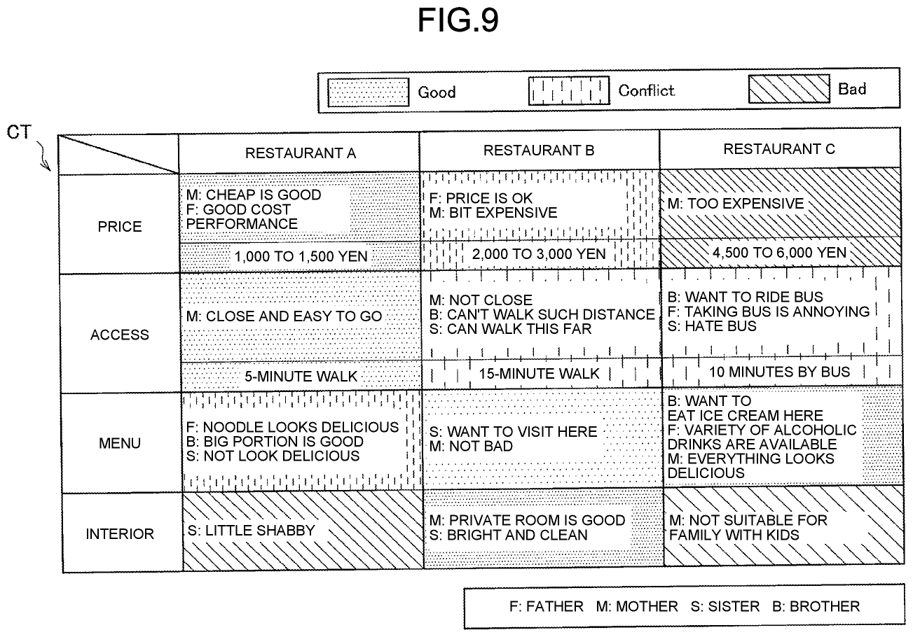

FIG. 9 is a diagram illustrating an example of the comparison table based on subjective evaluation speeches of a plurality of users according to the present embodiment. In the example illustrated in FIG. 9, similarly to the case of the single user, the comparison table CT in the form of a list in which a horizontal axis represents comparison targets and a vertical axis represents comparison items is generated.

Meanwhile, in the example illustrated in FIG. 9, unlike the case of the single user, symbols representing the respective speakers are added to the subjective expressions in each of the cells. In this manner, the output control unit 250 according to the present embodiment is able to generate the comparison table CT in which the subjective evaluations that are made by the plurality of users with respect to the contents related to the comparison targets are compared.

Furthermore, when comparative examinations are performed by the plurality of users, the output control unit 250 according to the present embodiment may generate the comparison table CT in which a comprehensive evaluation based on the subjective evaluations made by the plurality of users is represented for each of the comparison items.

For example, in the example illustrated in FIG. 9, the output control unit 250 represents an average value of the subjective evaluation scores by using red gradation with respect to an evaluation item for which positive subjective evaluation scores are obtained from all of the users, and represents an average value of the subjective evaluation scores by using blue gradation with respect to an evaluation item for which negative subjective evaluation scores are obtained from all of the users.

Moreover, the output control unit 250 according to the present embodiment may generate the comparison table in which a comparison item, for which the subjective evaluations made by the plurality of users conflict with each other, is emphasized by using a different color or the like. For example, in the example illustrated in FIG. 9, the users have conflicting opinions with respect to a comparison item of “access” of each of the restaurants B and C. In this case, the output control unit 250 is able to emphasize the comparison item by using a different color, such as yellow, from those of the comparison items for which the positive or negative subjective evaluation scores are obtained from all of the users, and by representing a variance value by changing color density.

According to the control performed by the output control unit 250 of the present embodiment as described above, it is possible to intuitively recognize the comparison item for which the subjective evaluations conflict with each other, and take a measure to find a compromise to the comparison item to settle a discussion.

Furthermore, when comparative examinations are performed by a plurality of users, the output control unit 250 may generate the comparison table such that display using the comparison targets and the comparison items on the axes and display using the comparison targets and the users on the axes are switchable.

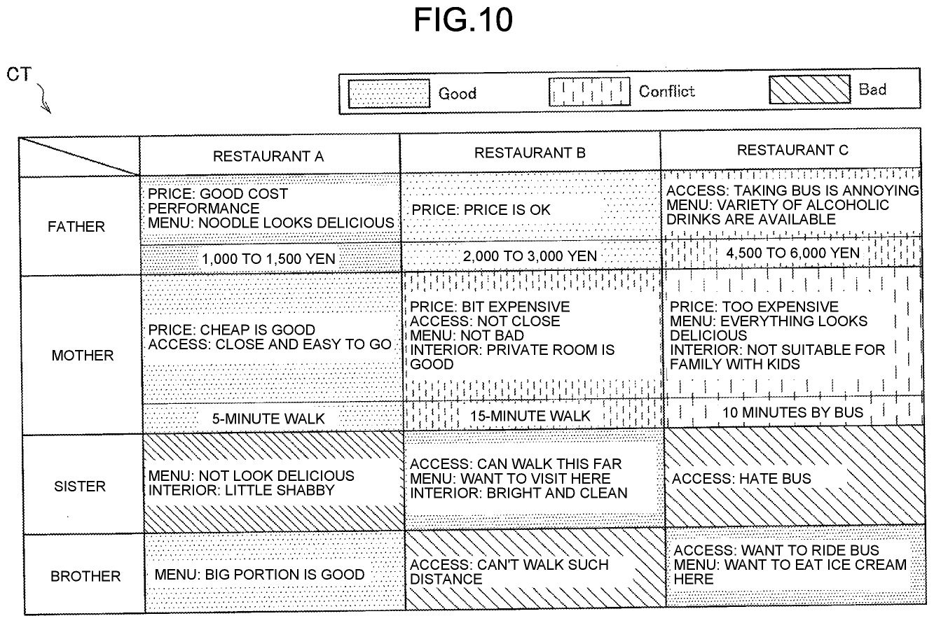

FIG. 10 illustrates an example of the comparison table using the comparison targets and the users on the axes according to the present embodiment. In the comparison table CT illustrated in FIG. 10, unlike FIG. 9, the vertical axis represents the users, and the comparison items are represented in each of the cells. With this display format, it is possible to clearly represent the subjective evaluation scores of each of the individuals with respect to the contents related to the comparison targets.

Furthermore, even when the comparative examinations are performed by the plurality of users, similarly to the case of an individual, the output control unit 250 may perform analysis with respect to the content related to the finally selected comparison target and the contents related to the non-selected comparison targets.

Moreover, when the comparative examinations are performed by the plurality of users, the output control unit 250 may analyze the user whose subjective evaluations are most strongly reflected in the final determination and may accumulate and use the analysis result. For example, in an environment, such as a family, in which harmonious relations are desired, it may be possible to more evenly reflect the subjective evaluations by searching for an initial content based on a preference of the user whose subjective evaluations are less frequently reflected in the final determination.

In contrast, in an environment, such as a meeting in an organization, in which quick decision-making is desired, it is expected to settle a discussion in a shorter time by searching for an initial content in accordance with orientation made by an individual whose subjective evaluations are more frequently reflected.

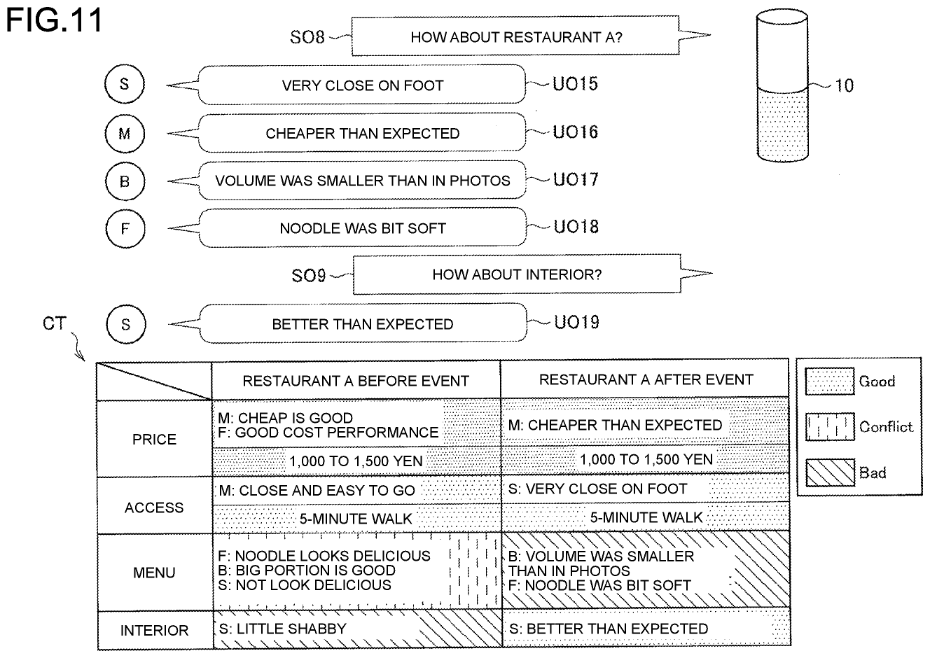

Meanwhile, the output control unit 250 according to the present embodiment is also able to analyze and use a difference between a subjective evaluation obtained before selection determination and an ex-post subjective evaluation obtained after the selection determination. FIG. 11 is a diagram for explaining use of ex-post subjective evaluations according to the present embodiment.

In an upper part in FIG. 11, one example of voice interactions that are made when the restaurant A was selected based on the comparison table CT as illustrated in FIG. 9 and FIG. 10 and the users who actually visited the restaurant A came home is illustrated.

In the example illustrated in FIG. 11, first, the output control unit 250 detects that all of the users are present, and causes the voice output unit 140 to output a system speech SO8 indicating a request to make ex-post subjective evaluation speeches with respect to the restaurant A. In this case, the output control unit 250 may re-present, to the users, the comparison table in which the subjective evaluations obtained before the selection determination are collected and the contents related to the comparison targets.

Furthermore, the output control unit 250 sequentially adds, to the comparison table CT, subjective expressions that are extracted from sequentially made subjective evaluation speeches UO15 to UO18. Meanwhile, if a comparison item for which an ex-post subjective expression is not obtained from any of the users is present, the output control unit 250 may cause the voice output unit 140 to output a system speech SO9 indicating a request to make an ex-post subjective evaluation speech on the comparison item.

Here, if the subjective evaluations on all of the comparison items are obtained by obtaining a subjective evaluation speech UO19 made by the user, the output control unit 250 calculates ex-post subjective evaluation scores and causes the display unit 150 to display the comparison table CT in which the scores are represented by different colors.

Furthermore, the output control unit 250 extracts and accumulates a difference between the subjective evaluation scores and the subjective expressions obtained before and after the event, with respect to the comparison item for which the difference between the subjective evaluation scores obtained before and after the event is equal to or larger than a predetermined threshold. The output control unit 250 is able to give a suggestion of various kinds of improvement to the contents provider side, by analyzing the above-described accumulated information.

For example, in the example illustrated in FIG. 11, it may be possible to give, to the contents provider, a suggestion of taking a photograph of the interior again because the user who made a negative subjective evaluation on the comparison item of “interior” before the event made a positive subjective evaluation after the event. Furthermore, it may be possible to give, to the contents provider, a suggestion to improve a menu itself or a cooking method because the user who made a positive subjective evaluation on the comparison item of “menu” before the event made a negative subjective evaluation after the event.

Generation of the comparison table with respect to contents related to comparison targets for which some of comparison items are not common according to the present embodiment will be described below. In the above description, the examples have been described in which contents related to a plurality of comparison targets have the same characteristics and it is possible to perform comparison based on completely identical comparison items.

In contrast, for example, in planning a birthday gift or the like, it may be expected that contents related to a plurality of comparison targets with different characteristics are compared. In this case, a comparison item that is not common among the contents related to the comparison targets may be present.

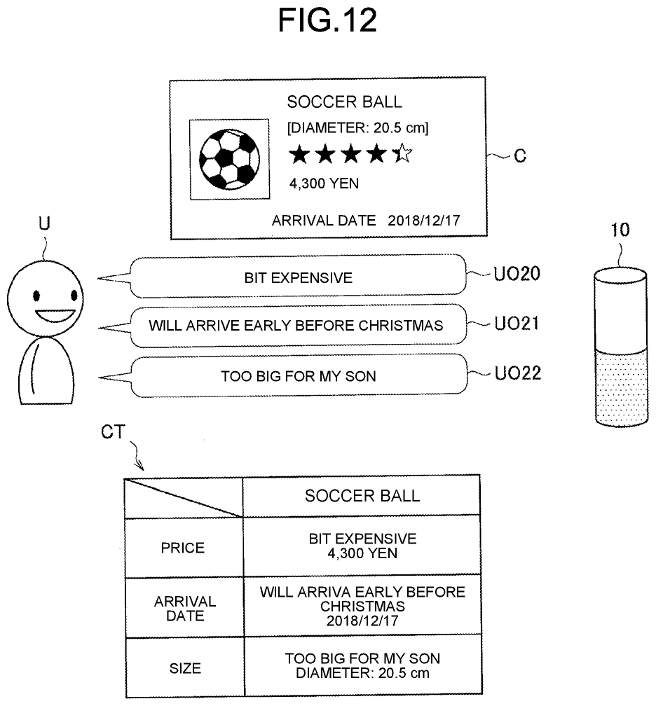

FIG. 12 to FIG. 14 are diagrams for explaining generation of the comparison table with respect to contents related to comparison targets for which some of the comparison items are not common according to the present embodiment. In an upper part in FIG. 12, an interaction between the user U who is planning a Christmas gift for a son and the information processing terminal 10.

In this case, similarly to the case of real-estate properties and restaurants, the output control unit 250 generates the comparison table CT based on comparison items that are extracted from subjective evaluation speeches UO20 to UO21 made by the user U with respect to contents related to comparison targets that are acquired as a result of search and based on subjective expressions, and causes the display unit 150 to display the comparison table CT.

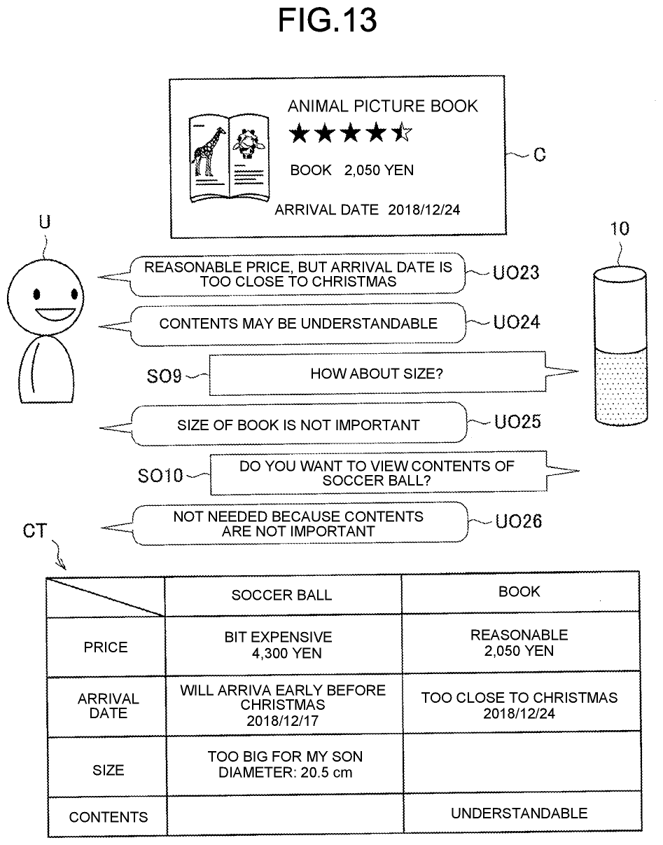

In contrast, in this example, unlike the examples as described above, the comparison targets have largely different characteristics. Specifically, in this example, as illustrated in FIG. 13, the user U is examining the comparison targets, such as a soccer ball and a book, that have largely different characteristics. Therefore, some of the comparison items are not common between the comparison targets as described above.

For example, the user U checks a content C related to the book that is the displayed comparison target, and makes subjective expression speeches UO23 and UO24 related to comparison items of “arrival date” and “contents”.

In this case, a subjective expression speech related to a comparison item of “size”, for which a speech has been made with respect to the content C related to the soccer ball, is not obtained with respect to the content C related to the book, and therefore, the output control unit 250 causes the voice output unit 140 to output the system speech SO9 indicating a request to make a subjective evaluation speech on the size of the book.

However, in general, the size of a book as a gift is not important, and therefore, the user U makes a speech UP29 indicating that the size of the book is not important in the comparative examination, in response to the system speech SO9.

In this case, the output control unit 250 may determine that “size” is not a common comparison item, on the basis of determination that a speech UO25 is not the subjective evaluation speech, where the determination is made by the natural language understanding unit 220.

Furthermore, because a subjective expression speech on the comparison item of “contents”, for which a speech has been made with respect to the content C related to the book, is not obtained with respect to the content C related to the soccer ball, the output control unit 250 causes the voice output unit 140 to output a system speech 5010 that proposes re-presentation of the content C related to the soccer ball to allow the user U to check “contents” of the soccer ball.

However, in general, there is no “contents” for the soccer ball, and therefore the user U makes a speech UO26 indicating that re-presentation of the content C is not needed.

In this case, the output control unit 250 may determine that “contents” is not a common comparison item on the basis of determination that the speech UO26 is not the subjective evaluation speech, where the determination is made by the natural language understanding unit 220.

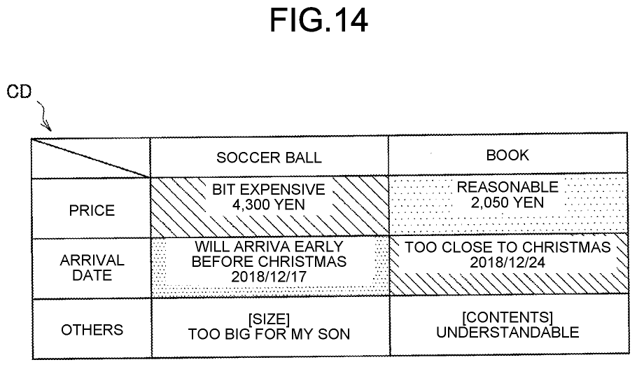

In this case, as illustrated in FIG. 14, the output control unit 250 according to the present embodiment may add an item of “others” for displaying items that are not common among the comparison targets, and display, in this item, subjective expressions with respect to the items that are not common.

In this case, the output control unit 250 may determine a background color of a comparison item that is common among the comparison targets, on the basis of the calculated subjective evaluation scores as described above. In contrast, as for the item of “others”, it is impossible to perform comparison in units of items, so that it is not necessary to control the background color.

In contrast, even in the item of “others”, presentation of the subjective evaluation score of each of the subjective expressions is important, and therefore, for example, the output control unit 250 may represent the subjective evaluation scores by changing a color, a size, or a decoration of text of the subjective expressions.

In this manner, the output control unit 250 according to the present embodiment is able to generate the comparison table of contents related to a plurality of comparison targets for which at least one of comparison items is not common.

### 1.6. Flow of Operation

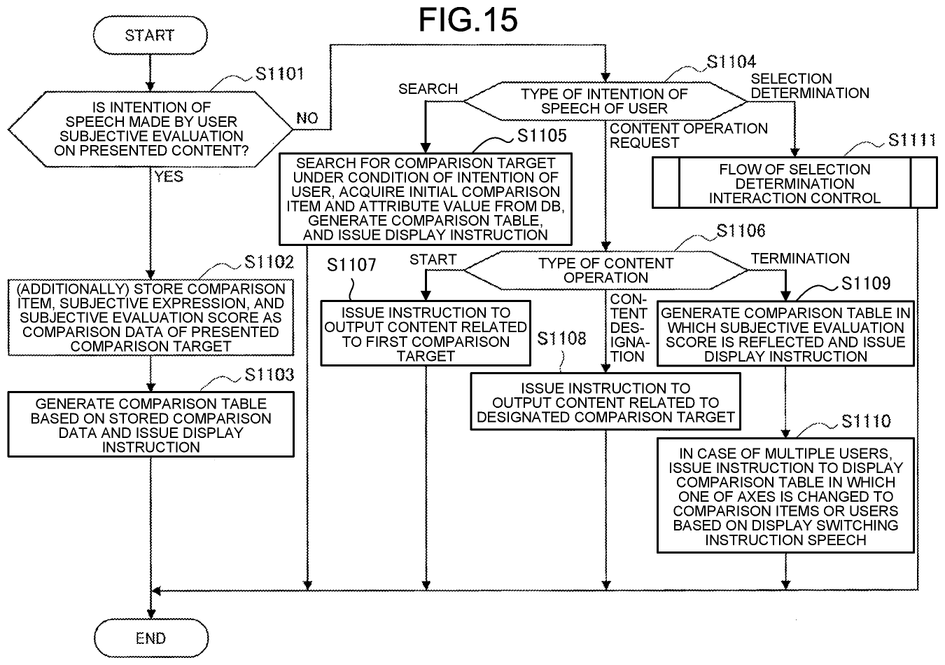

A flow of operation performed by the information processing server 20 according to the present embodiment will be described in detail below. First, the entire flow of control performed by the information processing server 20 will be described. FIG. 15 is a flowchart illustrating the entire flow of the control performed by the information processing server 20 according to the present embodiment.

With reference to FIG. 15, first, the natural language understanding unit 220 determines whether an intention of a speech made by the user is a subjective evaluation on a presented content, that is, whether the speech of the user is the subjective evaluation speech (S1101).

Here, if the intention of the speech made by the user is the subjective evaluation on the presented content (S1101: YES), the natural language understanding unit 220 stores the comparison item, the subjective expression, and the subjective evaluation score as comparison data of the comparison target (S1102).

Subsequently, the output control unit 250 generates the comparison table on the basis of the stored comparison data and issues a display instruction (S1103).

In contrast, if the intention of the speech made by the user is not the subjective evaluation on the presented content (S1101: NO), operation of the information processing server 20 diverges depending on the intention of the speech of the user (S1104).

If the intention of the speech of the user is a search (S1104: search), the output control unit 250 searches for a comparison target under the condition of the intention of the speech, acquires an initial comparison item and an attribute value from the database, and generates the comparison table (S1105).

In contrast, if the intention of the speech of the user is a selection determination (S1104: selection determination), the information processing server 20 proceeds to a flow of selection determination interaction control (to be described later) (S1111).

Further, if the intention of the speech of the user is a content operation request (S1104: content operation request), the operation of the information processing server 20 diverges depending on a type of content operation (S1106).

Here, if the content operation request from the user is a start of the content (S1106: start), the output control unit 250 issues an instruction to output a content related to a first comparison target (S1107).

In contrast, if the content operation request from the user is designation of a content (S1106: content designation), the output control unit 250 issues an instruction to output a content related to a designated comparison target (S1108).

Further, if the content operation request from the user is a termination of a content (S1106: termination), the output control unit 250 generates the comparison table in which the subjective evaluation score is reflected, and issues a display instruction (S1109).

Furthermore, if a plurality of users are present at this time, the output control unit 250 issues an instruction to display the comparison table in which one of axes is changed to the comparison items or the users on the basis of a display switching instruction speech made by the user (S1110).

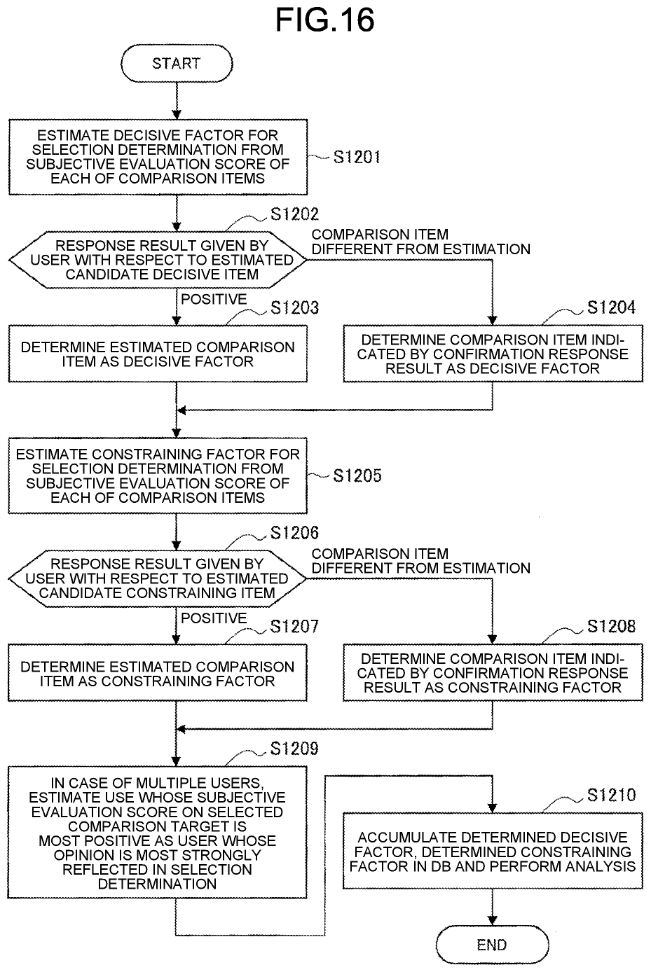

Thus, the entire flow of the control performed by the information processing server 20 has been described above. Next, the flow of the selection determination interaction control performed by the information processing server 20 according to the present embodiment will be described. FIG. 16 is a flowchart illustrating the flow of the selection determination interaction control performed by the information processing server 20 according to the present embodiment.

With reference to FIG. 16, first, the output control unit 250 estimates a (positive) decisive factor for the selection determination performed by the user, from the subjective evaluation score of each of the comparison items (S1201).

Subsequent operation of the output control unit 250 diverges depending on a confirmation response result that is given by the user with respect to an estimated candidate decisive item (S1202).

Here, if the confirmation response result given by the user is positive (S1202: positive), the output control unit 250 determines the estimated comparison item as the decisive factor (S1203).

In contrast, if the confirmation response result given by the user indicates a comparison item different from the estimated comparison item (S1202: comparison item different from estimation), the output control unit 250 determines the comparison item indicated by the confirmation response result as the decisive factor (S1204).

If the decisive factor is determined at Step S1203 or S1204, the output control unit 250 subsequently estimates a (negative) constraining factor for the selection determination performed by the user, from the subjective evaluation score of each of the comparison items (S1205).

Subsequent operation of the output control unit 250 diverges depending on a confirmation response result that is given by the user with respect to the estimated candidate constraining item (S1206).

Here, if the confirmation response result given by the user is positive (S1206: positive), the output control unit 250 determines the estimated comparison item as the constraining factor (S1207).

In contrast, if the confirmation response result given by the user indicates a comparison item different from the estimated comparison item (S1206: comparison item different from estimation), the output control unit 250 determines the comparison item indicated by the confirmation response result as the constraining factor (S1208).

Further, if a plurality of users are present at this time, the output control unit 250 estimates a user whose subjective evaluation score on the selected comparison target is the most positive as a user whose opinion is most strongly reflected in the selection determination (S1209).

Subsequently, the output control unit accumulates the determined decisive factor, the determined constraining factor, and the user whose opinion is most strongly reflected in the selection determination if the plurality of users are present in the database, and performs statistical analysis (S1210).

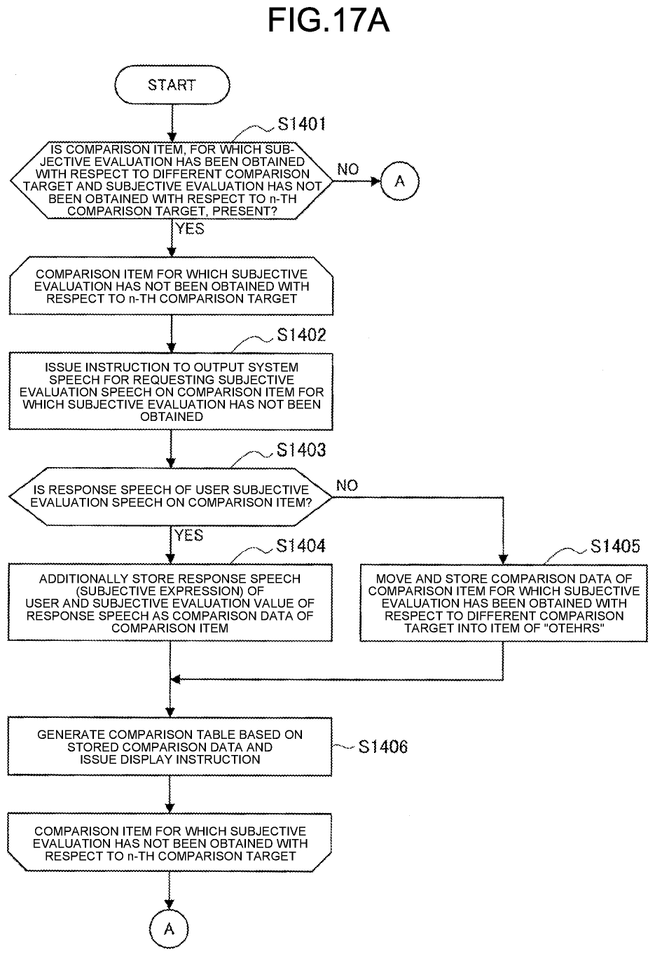

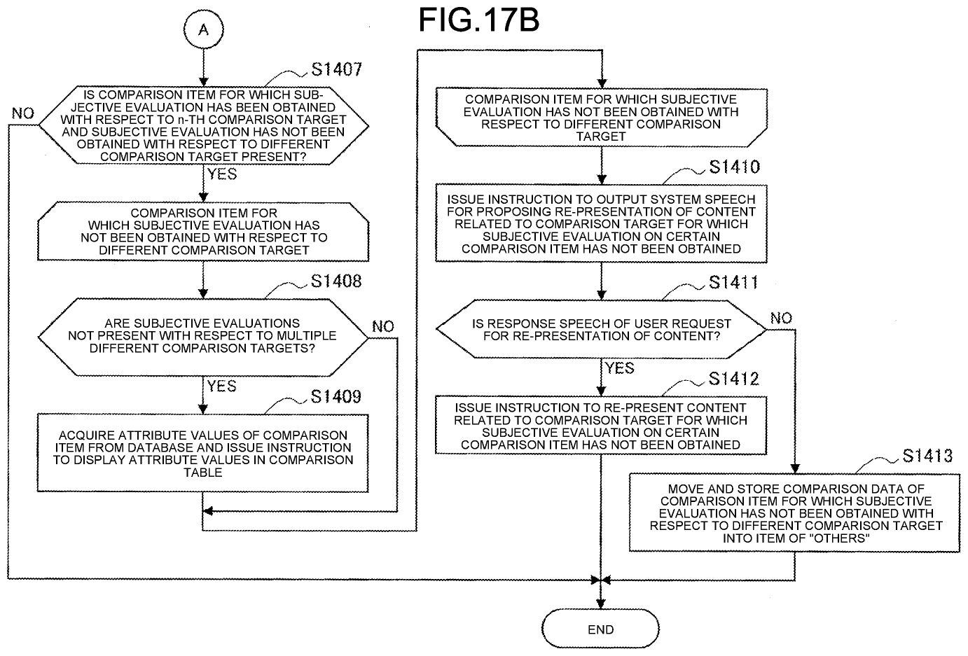

Thus, the flow of the selection determination interaction control performed by the information processing server 20 has been described above. Next, control of making a comparative evaluation criterion uniform by the information processing server 20 according to the present embodiment will be described. FIG. 17A and FIG. 17B are flowcharts illustrating the flow of the control of making the comparative evaluation criterion uniform by the information processing server 20 according to the present embodiment.

With reference to FIG. 17A, first, the output control unit 250 determines whether a comparison item, for which a subjective evaluation has been obtained with respect to a different comparison target and a subjective evaluation has not been obtained with respect to an n-th comparison target, is present (S1401).

Here, if the comparison item that meets the condition as described above is not present (S1401: NO), the output control unit 250 transits to a state A.

In contrast, if the comparison item that meets the condition as described above is present (S1401: YES), the output control unit 250 repeats the operation at Steps S1402 to S1406 below on the comparison item for which the subjective evaluation has not been obtained with respect to the n-th comparison target, and if the processes on all of the comparison items are completed, the output control unit 250 transits to the state A.

Specifically, the output control unit 250 issues an instruction to output a system speech for requesting a subjective evaluation speech on the comparison item for which the subjective evaluation has not been obtained (S1402).

Subsequently, the natural language understanding unit 220 determines whether a response speech of the user is the subjective evaluation speech on the comparison item (S1403).

Here, if the response speech of the user is the subjective evaluation speech on the comparison item (S1403: YES), the natural language understanding unit 220 additionally stores the response speech (the subjective expression) and a subjective evaluation score of the response speech as the comparison data of the comparison item (S1404).

In contrast, if the response speech of the user is not the subjective evaluation speech on the comparison item (S1403: NO), the output control unit 250 moves and stores the comparison data of the comparison item for which the subjective evaluation has been obtained with respect to the different comparison target into the item of “others” (S1405).

If the process at Step S1404 or S1405 is completed, the output control unit 250 generates the comparison table based on the stored comparison data and issues a display instruction (S1406).

Next, the flow of operation performed after transition to the state A will be described with reference to FIG. 17B.

The output control unit 250 determines whether a comparison item for which a subjective evaluation has been obtained with respect to the n-th comparison target and a subjective evaluation has not been obtained with respect to a different comparison targets is present (S1407).

Here, if the comparison item that meets the condition as described above is not present (S1407: NO), the information processing server 20 terminates the series of processes.

In contrast, if the comparison item that meets the condition as described above is present (S1407: YES), the output control unit 250 repeats operation at Steps S1408 and S1409 below with respect to the comparison item for which the subjective evaluation has not been obtained with respect to the different comparison target.

The output control unit 250 determines whether subjective evaluations on the comparison item are not present with respect to a plurality of different comparison targets (S1408).

Here, if the subjective evaluations on the comparison item are not present with respect to the plurality of different comparison targets (S1408: YES), the output control unit 250 acquires attribute values of the comparison item from the database, and issues an instruction to display the attribute values in the comparison table (S1409).

After a repetition process at Steps S1408 and S1409 is completed, the output control unit 250 issues an instruction to output a system speech for proposing re-presentation of the content related to the comparison target for which the subjective evaluation on a certain comparison item has not been obtained (S1410).

Subsequently, the natural language understanding unit 220 determines whether a response speech of the user is a request for re-presentation of the content (S1411).

Here, if the response speech of the user is a request for re-presentation of the content (S1411: YES), the output control unit 250 gives an instruction to re-present the content related to the comparison target for which the subjective evaluation on the certain comparison item has not been obtained (S1412).

In contrast, if the response speech of the user is not a request for re-presentation of the content (S1411: NO), the output control unit 250 moves and stores comparison data of the comparison item for which the subjective evaluation has not been obtained with respect to the different comparison target into the item of “others” (S1413).

### 1.7. Other Control

Thus, the functions of the information processing server 20 according to the present embodiment have been described above. Meanwhile, the information processing server 20 according to the present embodiment need not always perform the control as described above, but may additionally perform various kinds of control.

For example, the output control unit 250 according to the present embodiment may determine a search condition for a comparison target in accordance with various profiles, such as age and gender, of the user.

Furthermore, while the example has been described above in which the comparison item that is extracted from the subjective evaluation speech is inserted on the lower side in the comparison table, it may be possible to perform control of rearranging the comparison item to the upper side if it is detected that the user gives higher priority to the comparison item. For example, the output control unit 250 may increase the priority of a subjective evaluation that is made by the user based on a first impression on the comparison target, and display the subjective evaluation on the information in the comparison table. Furthermore, the output control unit 250 may perform control of displaying, on the lower side, a comparison item for which there is usually little difference among the subjective evaluation scores or a comparison item for which variance is small.

Moreover, if a plurality of users are not able to determine a selection, the output control unit 250 may perform a selection determination on behalf of the users, on the basis of current subjective evaluation scores. Furthermore, the output control unit 250 may calculate a sum of the subjective evaluation scores that are made by the users with respect to all of the comparison items of each of the comparison targets, and display a total score of each of the comparison targets. Moreover, the output control unit 250 is able to output a system speech that suggests a comparison target that has the highest total score.

Furthermore, the information processing system according to the present embodiment may be adopted to, for example, a car navigation system. In this case, the car navigation system may detect conversations about a destination by users in the vehicle, and display a comparison table in which subjective evaluations on each of the destinations are reflected.

Moreover, while the case has been descried above in which the output control unit 250 according to the present embodiment generates the comparison table through a voice interaction with the user, the voice interaction is not always needed. The output control unit 250 according to the present embodiment is also able to generate the comparison table based on, for example, subjective evaluations that are extracted from interactions between a real agent, a real concierge, a real operator, or the like and the user.

For example, if the user views a property together with a real agent who deals with the property, the output control unit 250 may generate the comparison table based on subjective evaluations that are obtained from speeches of both of the user and the agent and that are collected by a tablet or the like carried by the agent, and cause the tablet to display the comparison table.

In this case, the agent is able to check the comparison item for which a subjective evaluation has not been obtained in the comparison table, and directly ask the user about the subjective evaluation on the comparison item. In this manner, the information processing system according to the present embodiment is also used as a sales assistant tool.

### 2. HARDWARE CONFIGURATION EXAMPLE

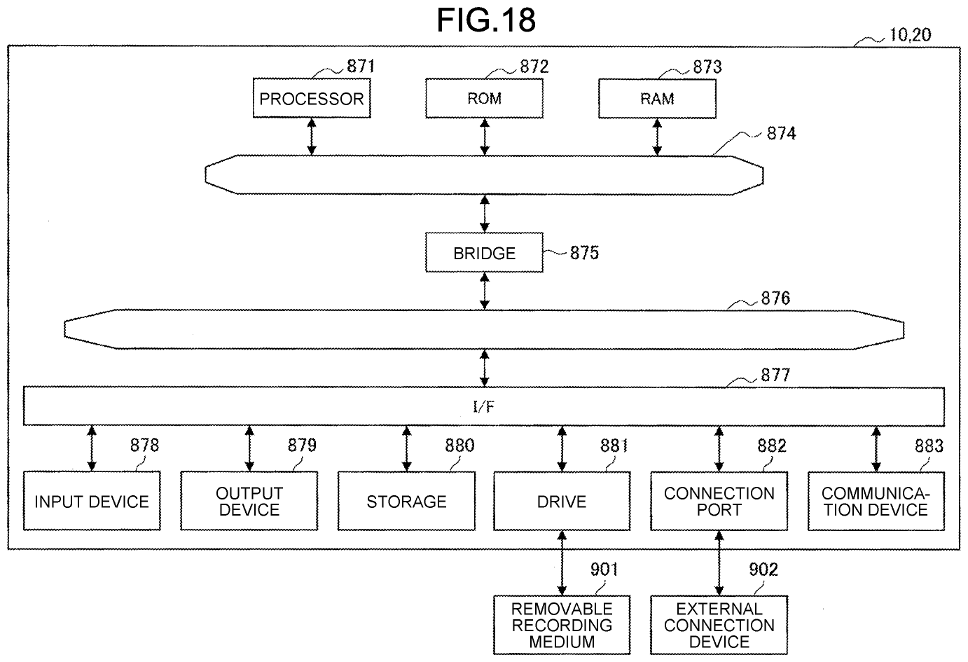

A hardware configuration example of the information processing terminal 10 and the information processing server 20 according to one embodiment of the present disclosure will be described below. FIG. 18 is a block diagram illustrating a hardware configuration example of the information processing terminal 10 and the information processing server 20 according to one embodiment of the present disclosure. As illustrated in FIG. 18, each of the information processing terminal 10 and the information processing server 20 includes, for example, a processor 871, a read only memory (ROM) 872, a random access memory (RAM) 873, a host bus 874, a bridge 875, an external bus 876, an interface 877, an input device 878, an output device 879, a storage 880, a drive 881, a connection port 882, and a communication device 883. The hardware configuration described herein is one example, and a part of the structural elements may be omitted. Further, it may be possible to include other structural elements in addition to the structural elements described herein.

Processor 871

The processor 871 functions as, for example, an arithmetic processing device or a control device, and controls all or a part of operation of each of the structural elements on the basis of various programs that are stored in the ROM 872, the RAM 873, the storage 880, or a removable recording medium 901.

ROM 872 and RAM 873

The ROM 872 is a means for storing a program to be read by the processor 871, data used for calculation, and the like. The RAM 873 temporarily or permanently stores therein, for example, a program to be read by the processor 871, various parameters that are appropriately changed at the time of execution of the program, and the like.

Host Bus 874, Bridge 875, External Bus 876, and Interface 877

The processor 871, the ROM 872, and the RAM 873 are connected to one another via the host bus 874 that is able to transmit data at a high speed, for example. In contrast, the host bus 874 is connected, via the bridge 875, to the external bus 876 for which a data transmission speed is relatively low, for example. Further, the external bus 876 is connected to various structural elements via the interface 877.

Input Device 878

As the input device 878, for example, a mouse, a keyboard, a touch panel, a button, a switch, a lever, or the like is used. Further, as the input device 878, a remote controller (hereinafter, a remote) that is able to transmit a control signal using infrared or other radio waves may be used. Furthermore, the input device 878 includes a voice input device, such as a microphone.

Output Device 879

The output device 879 is, for example, a device, such as a display device, e.g., a cathode ray tube (CRT), a liquid crystal display (LCD), or an organic electroluminescence display, an audio output device, e.g., a speaker or a headphone, a printer, a mobile phone, or a facsimile machine, that is able to visually or auditorily notify the user of acquired information. Further, the output device 879 according to the present disclosure includes various vibration devices that are able to output tactile stimuli.

Storage 880

The storage 880 is a device for storing various kinds of data. As the storage 880, for example, a magnetic storage device, such as a hard disk drive (HDD), a semiconductor storage device, an optical storage device, a magneto optical storage device, or the like may be used.

Drive 881

The drive 881 is a device that reads information recorded in the removable recording medium 901, such as a magnetic disk, an optical disk, a magneto optical disk, or a semiconductor memory, or writes information to the removable recording medium 901.

Removable Recording Medium 901

The removable recording medium 901 is, for example, a digital versatile disk (DVD) medium, a Blu-ray (registered trademark) medium, an HD DVD medium, various semiconductor storage media, or the like. The removable recording medium 901 may of course be, for example, an integrated circuit (IC) card equipped with a contactless IC chip, an electronic device, or the like.

Connection Port 882

The connection port 882 is, for example, a port, such as a universal serial bus (USB) port, an IEEE 1394 port, a small computer system interface (SCSI), an RS-232C port, or an optical audio terminal, for connecting an external connection device 902.

External Connection Device 902

The external connection device 902 is, for example, a printer, a portable music player, a digital camera, a digital video camera, an IC recorder, or the like.

Communication Device 883

The communication device 883 is a communication device for establishing a connection to a network, and is, for example, a communication card for a wired or wireless LAN, Bluetooth (registered trademark), or wireless USB (WUSB), a router for optical communication, a router for asymmetric digital subscriber line (ADSL), a modem for various kinds of communication, or the like.

### 3. CONCLUSION

As described above, the information processing server 20 according to one embodiment of the present disclosure includes the output control unit 250 that controls display of a table in which subjective evaluations that are made by the user on contents are collected, on the basis of an extracted intention of a speech of the user. Further, the output control unit 250 according to one embodiment of the present disclosure generates a comparison table in which the subjective evaluations are compared for each of contents related to a plurality of comparison targets, and displays the comparison table. With this configuration, it is possible to accurately organize divergent feedbacks and opinions of the user with respect to a plurality of comparison targets without a burden on the user.

While the preferred embodiments of the present disclosure have been described in detail above with reference to the accompanying drawings, the technical scope of the present disclosure is not limited to the examples as described above. It is obvious that a person skilled in the technical field of the present disclosure may conceive various alternations and modifications within the scope of the appended claims, and it should be understood that they will naturally come under the technical scope of the present disclosure.

Furthermore, the effects described in this specification are merely illustrative or exemplified effects, and are not limitative. That is, with or in the place of the above effects, the technology according to the present disclosure may achieve other effects that are clear to those skilled in the art from the description of this specification.

Moreover, it is possible to generate a program that causes hardware, such as a CPU, a ROM, and a RAM, that is incorporated in a computer to implement the same functions as those of the information processing server 20, and it may be possible to provide a non-transitory computer readable recording medium with the program recorded thereon.

Furthermore, each of Steps related to the processes performed by the information processing server 20 according to the present specification need not always be processed in chronological order as illustrated in the flowchart. For example, each of Steps related to the processes performed by the information processing server 20 may be performed in different order from the order illustrated in the flowchart, or may be performed in a parallel manner.

In addition, the following configurations are also within the technical scope of the present disclosure.

(1)

An information processing apparatus comprising:

an output control unit that controls display of a table in which subjective evaluations that are made by a user on contents are collected, on the basis of an extracted intention of a speech of the user, wherein

the output control unit generates a comparison table in which the subjective evaluations are compared for each of contents related to a plurality of comparison targets, and displays the comparison table.

(2)

The information processing apparatus according to (1), wherein the output control unit generates the comparison table in which the subjective evaluations are compared for each of comparison items included in the contents related to the comparison targets.

(3)

The information processing apparatus according to (2), wherein

the subjective evaluations include subjective expressions with respect to the comparison items extracted from the speech of the user, and subjective evaluation scores that are calculated from the subjective expressions, and

the output control unit generates the comparison table in which the subjective expressions and the subjective evaluation scores are compared for each of the comparison items.

(4)

The information processing apparatus according to (3), wherein if a new comparison item is extracted from the speech of the user, the output control unit adds the new comparison item to the comparison table.

(5)

The information processing apparatus according to (3) or (4), wherein the output control unit generates the comparison table in which the subjective evaluation scores are represented by backgrounds of the comparison items.

(6)

The information processing apparatus according to (5), wherein the output control unit generates the comparison table in which polarities and magnitudes of the subjective evaluation scores are represented by one of a color and a pattern of the backgrounds of the comparison items.

(7)

The information processing apparatus according to any one of (3) to (6), wherein the output control unit further controls a voice interaction with the user with respect to the contents related to the comparison targets, and generates the comparison table based on an intention of a speech of the user, the intention being extracted in the voice interaction.

(8)

The information processing apparatus according to (6), wherein the output control unit outputs a system speech for requesting the user to make a subjective evaluation speech on the comparison item for which the subjective evaluation has not been obtained.

(9)

The information processing apparatus according to (8), wherein the output control unit controls a system speech such that, with respect to the comparison items for which the subjective evaluations are obtained in the contents related to one or more comparison targets, subjective evaluations are obtained in the contents related to all of the comparison targets.

(10)

The information processing apparatus according to any one of (3) to (9), wherein the output control unit further controls presentation of the contents related to the comparison targets.

(11)

The information processing apparatus according to (10), wherein if the comparison item for which the subjective evaluation has not been obtained is present in the contents related to the presented comparison targets, the output control unit controls re-presentation of the contents related to the already-presented comparison targets.

(12)

The information processing apparatus according to any one of (3) to (11), wherein the output control unit generates the comparison table in which the subjective evaluations that are made by a plurality of users on the contents related to the comparison targets are compared.

(13)

The information processing apparatus according to (12), wherein the output control unit generates the comparison table in which a total evaluation based on the subjective evaluation scores made by the plurality of users is represented for each of the comparison items.

(14)

The information processing apparatus according to (13), wherein the output control unit generates the comparison table in which the comparison item for which the subjective evaluations made by the plurality of users conflict with each other is emphasized.

(15)

The information processing apparatus according to any one of (12) to (14), wherein the output control unit generates the comparison table such that display using the comparison targets and the comparison items on axes and display using the comparison targets and the users on axes are switchable.

(16)

The information processing apparatus according to any one of (3) to (15), wherein the output control unit generates the comparison table of the contents related to the comparison targets for which at least one of the comparison items is not common.

(17)

The information processing apparatus according to any one of (3) to (16), wherein if the user makes a determination to select one of the contents related to the comparison targets, the output control unit estimates the comparison item that serves as a decisive factor for the determination made by the user, on the basis of the subjective evaluation scores.

(18)

The information processing apparatus according to (17), wherein if the user makes a determination to select one of the contents related to the comparison targets, the output control unit estimates the comparison item that serves as a constraining factor for the contents related to the comparison targets that are not selected by the user, on the basis of the subjective evaluation scores.

(19)

The information processing apparatus according to any one of (3) to (18), further comprising:

a natural language understanding unit that extracts the comparison items and the subjective evaluations on the basis of the speech of the user.

(20)

An information processing method comprising:

controlling, by a processor, display of a table in which subjective evaluations that are made by a user on contents are collected, on the basis of an extracted intention of a speech of the user, wherein

the controlling includes
generating a comparison table in which the subjective evaluations are compared for each of contents related to a plurality of comparison targets, and
displaying the comparison table.

### REFERENCE SIGNS LIST

10 information processing terminal
110 voice input unit
120 imaging unit
130 control unit
140 voice output unit
150 display unit
information processing server
210 voice recognition unit
220 natural language understanding unit
230 image recognition unit
240 speaker identification unit
250 output control unit
260 voice synthesis unit

1. An information processing apparatus comprising:
an output control unit that controls display of a table in which subjective evaluations that are made by a user on contents are collected, on the basis of an extracted intention of a speech of the user, wherein
the output control unit generates a comparison table in which the subjective evaluations are compared for each of contents related to a plurality of comparison targets, and displays the comparison table.

2. The information processing apparatus according to claim 1, wherein the output control unit generates the comparison table in which the subjective evaluations are compared for each of comparison items included in the contents related to the comparison targets.

3. The information processing apparatus according to claim 2, wherein
the subjective evaluations include subjective expressions with respect to the comparison items extracted from the speech of the user, and subjective evaluation scores that are calculated from the subjective expressions, and
the output control unit generates the comparison table in which the subjective expressions and the subjective evaluation scores are compared for each of the comparison items.

4. The information processing apparatus according to claim 3, wherein if a new comparison item is extracted from the speech of the user, the output control unit adds the new comparison item to the comparison table.

5. The information processing apparatus according to claim 3, wherein the output control unit generates the comparison table in which the subjective evaluation scores are represented by backgrounds of the comparison items.

6. The information processing apparatus according to claim 5, wherein the output control unit generates the comparison table in which polarities and magnitudes of the subjective evaluation scores are represented by one of a color and a pattern of the backgrounds of the comparison items.

7. The information processing apparatus according to claim 3, wherein the output control unit further controls a voice interaction with the user with respect to the contents related to the comparison targets, and generates the comparison table based on an intention of a speech of the user, the intention being extracted in the voice interaction.

8. The information processing apparatus according to claim 6, wherein the output control unit outputs a system speech for requesting the user to make a subjective evaluation speech on the comparison item for which the subjective evaluation has not been obtained.

9. The information processing apparatus according to claim 8, wherein the output control unit controls a system speech such that, with respect to the comparison items for which the subjective evaluations are obtained in the contents related to one or more comparison targets, subjective evaluations are obtained in the contents related to all of the comparison targets.

10. The information processing apparatus according to claim 3, wherein the output control unit further controls presentation of the contents related to the comparison targets.

11. The information processing apparatus according to claim 10, wherein if the comparison item for which the subjective evaluation has not been obtained is present in the contents related to the presented comparison targets, the output control unit controls re-presentation of the contents related to the already-presented comparison targets.

12. The information processing apparatus according to claim 3, wherein the output control unit generates the comparison table in which the subjective evaluations that are made by a plurality of users on the contents related to the comparison targets are compared.

13. The information processing apparatus according to claim 12, wherein the output control unit generates the comparison table in which a total evaluation based on the subjective evaluation scores made by the plurality of users is represented for each of the comparison items.

14. The information processing apparatus according to claim 13, wherein the output control unit generates the comparison table in which the comparison item for which the subjective evaluations made by the plurality of users conflict with each other is emphasized.

15. The information processing apparatus according to claim 12, wherein the output control unit generates the comparison table such that display using the comparison targets and the comparison items on axes and display using the comparison targets and the users on axes are switchable.

16. The information processing apparatus according to claim 3, wherein the output control unit generates the comparison table of the contents related to the comparison targets for which at least one of the comparison items is not common.

17. The information processing apparatus according to claim 3, wherein if the user makes a determination to select one of the contents related to the comparison targets, the output control unit estimates the comparison item that serves as a decisive factor for the determination made by the user, on the basis of the subjective evaluation scores.

18. The information processing apparatus according to claim 17, wherein if the user makes a determination to select one of the contents related to the comparison targets, the output control unit estimates the comparison item that serves as a constraining factor for the contents related to the comparison targets that are not selected by the user, on the basis of the subjective evaluation scores.

19. The information processing apparatus according to claim 3, further comprising:
a natural language understanding unit that extracts the comparison items and the subjective evaluations on the basis of the speech of the user.

20. An information processing method comprising:
controlling, by a processor, display of a table in which subjective evaluations that are made by a user on contents are collected, on the basis of an extracted intention of a speech of the user, wherein
the controlling includes
generating a comparison table in which the subjective evaluations are compared for each of contents related to a plurality of comparison targets, and
displaying the comparison table.
